(19) United States
(12) Patent Application Publication
(10) Pub. No.: US 2026/0363206 A1
(43) Pub. Date: Nov. 19, 2026

(54) SYSTEM FOR FEEDING ANIMALS, FEED CARRIAGE, AND USE OF SUCH A SYSTEM

(71) Applicant: LELY PATENT N.V., Maassluis (NL)

(72) Inventor: Matthew VAN MEURS, Maassluis (NL)

(73) Assignee: LELY PATENT N.V., Maassluis (NL)

(21) Appl. No.: 19/515,534

(22) PCT Filed: Sep. 11, 2024
(86) PCT No.: PCT/IB2024/058828

§ 371 Date: Mar. 2, 2026

(30) Foreign Application Priority Data
Sep. 14, 2023 (NL) 2035798

(51) Int. Cl. A01K 5/02

(52) U.S. Cl. CPC A01K 5/0266; A01K 5/0283

(57) ABSTRACT

A system for feeding animals, such as cows, comprises a feed carriage. The feed carriage comprises a frame with wheels, by means of which the feed carriage is moveable over an underlying surface, such as a floor. A container for receiving a batch of feed is fitted to the frame. A weighing system having at least one weighing sensor is provided for weighing feed received in the container. The system comprises at least one jack, which is actuatable between a lowering position and a raising position. The frame comprises at least one wheel jacking point for fitting the jack below the frame in such a way that (i) the wheel closest to the wheel jacking point is supported on the underlying surface when the jack is fitted in the lowering position at the wheel jacking point, and (ii) the jack fitted at the wheel jacking point lifts up the frame in order to release this wheel from the underlying surface when the jack is actuated from the lowering position to the raising position. The frame further comprises at least one weighing sensor jacking point for fitting this same jack in such a way that (i) the container is supported on the frame by means of the weighing sensor when the jack is fitted in the lowering position at the weighing sensor jacking point, and (ii) the jack fitted at the weighing sensor jacking point lifts up the container in order to relieve the load on the weighing sensor when the jack is actuated from the lowering position to the raising position. The jack therefore has a dual function.

The invention relates to a system for feeding animals, such as cows, wherein the system is provided with a feed carriage and at least one jack.

The Lely Vector® automatic feeding system is known. This feeding system comprises an autonomous feed carriage which is provided with a frame with three wheels, by means of which the feed carriage is moveable over an underlying surface, such as a floor. The feed carriage comprises a container for receiving a batch of feed. The container is fitted to the frame. The feed carriage comprises a weighing system having three weighing sensors for weighing feed received in the container. During the weighing, the container rests on the frame by means of the weighing sensors.

For transport of the feed carriage in a lorry, for example in order to deliver the feed carriage from the factory to a farm or in order to bring the feed carriage from one farm to another, the feed carriage is placed on a pallet and firmly secured to the loading floor of the lorry by means of lashing straps. In this case, there is the risk of the exerted tensioning force resulting in damage to the weighing sensors due to the maximum load of the weighing sensors being exceeded.

An object of the invention is to provide an improved system for feeding animals, wherein it is in particular ensured in a simple and efficient manner that the weighing system for weighing feed in the feed carriage is damaged less quickly during transport.

This object is achieved according to the invention by means of a system for feeding animals, such as cows, in particular dairy cows or beef cows, wherein the system comprises:
a feed carriage which is provided with:
   a frame with wheels, by means of which the feed carriage is moveable over an underlying surface, such as a floor,
   a container for receiving a batch of feed, wherein the container is fitted to the frame,
   a weighing system for weighing feed received in the container, wherein the weighing system comprises at least one weighing sensor, and
at least one jack, which is actuatable and/or adjustable between a lowering position and a raising position, and is preferably securable in the lowering position and in the raising position, for example by means of a lock nut,
   the frame of the feed carriage comprises:
at least one wheel jacking point for fitting the jack below the frame in such a way that (i) the wheel closest to the wheel jacking point is supported on the underlying surface when the jack is fitted in the lowering position at the wheel jacking point, and (ii) the jack fitted at the wheel jacking point lifts up the frame in order to release this wheel from the underlying surface when the jack is actuated and/or adjusted from the lowering position to the raising position, and
at least one weighing sensor jacking point for fitting this same jack in such a way that (i) the container is supported on the frame by means of the weighing sensor when the jack is fitted in the lowering position at the weighing sensor jacking point, and (ii) the jack fitted at the weighing sensor jacking point lifts up the container in order to relieve the load on the weighing sensor when the jack is actuated and/or adjusted from the lowering position to the raising position.

According to the invention, the at least one jack has a dual function. The first function is known per se: the lifting up of the feed carriage in order to change one or more of the wheels. The frame comprises, for at least one of the wheels, a wheel jacking point for fitting the jack below the frame. In order to change this wheel, for example during maintenance, the jack is fitted in the lowering position at the wheel jacking point. In order to form the at least one wheel jacking point, the frame is locally reinforced in order to bear the jacking forces. In other words, each wheel jacking point comprises a locally reinforced portion of the frame that is designed to bear the jacking forces when the feed carriage is lifted up. After the jack has been fitted in the lowering position at the wheel jacking point, the jack is actuated from the lowering position to the raising position in order to lift up the frame, such that the wheel comes free from the underlying surface. The wheel can then be replaced. When a plurality of jacks are used, it is possible to replace a plurality or all of the wheels at the same time.

According to the invention, the at least one jack has a second function. According to the invention, these same one or more jacks are also used to relieve the load on the one or more weighing sensors during transport. The frame comprises, for the or each weighing sensor, a weighing sensor jacking point for the fitting of the jack. Prior to transport in a lorry, for each weighing sensor, a respective jack is fitted in the lowering position at the corresponding weighing sensor jacking point. After that, the one or more jacks are actuated from the lowering position to the raising position in order to lift up the container, such that the or each weighing sensor of the weighing system is relieved of load. The container then rests on these one or more jacks. When the feed carriage is subsequently braced on the loading floor of the lorry by means of lashing straps, the container of the feed carriage is supported against the one or more jacks. During transport, the one or more jacks form a stop, such that the one or more weighing sensors are protected against overloading.

By virtue of the above-described dual function of the one or more jacks, only minimal modifications to the frame are necessary to prevent damage during transport due to overloading of the one or more weighing sensors. According to the invention, for each weighing sensor, a respective weighing sensor jacking point is integrated into the frame. In order to form the at least one weighing sensor jacking point, the frame is locally reinforced in order to bear the jacking forces. In other words, each weighing sensor jacking point comprises a locally reinforced portion of the frame that is designed to bear the jacking forces when the container is lifted up. The weighing sensor jacking point is also designed to bear the forces exerted when the feed carriage is tensioned on the loading floor of a lorry. However, apart from the weighing sensor jacking points integrated into the frame, it is not necessary to add additional components or mechanisms in order to protect the container from overloading during transport in the lorry. Each weighing sensor jacking point is designed in such a way that the jack which is designed to be fitted at the wheel jacking point, i.e. is usable at the wheel jacking point in order to lift up the feed carriage so as to change one or more of the wheels, can also be fitted at the weighing sensor jacking point, in particular in order to relieve the load on the one or more weighing sensors during transport. This ensures in a simple and efficient manner that the weighing system is damaged less quickly during transport.

In an embodiment according to the invention, the weighing system comprises at least three weighing sensors and the system comprises at least three jacks, wherein the frame of the feed carriage comprises at least three weighing sensor jacking points for fitting a respective one of the jacks in such a way that (i) the container is supported on the frame by means of the weighing sensors when the jacks are fitted in the lowering position at the weighing sensor jacking points, and (ii) the jacks fitted at the weighing sensor jacking points lift up the container in order to relieve the load on the weighing sensors when the jacks are actuated and/or adjusted from the lowering position to the raising position. A respective corresponding weighing sensor jacking point is added to each weighing sensor. Preferably, the number of jacks is at least equal to the number of weighing sensors and the number of weighing sensor jacking points. In other words, if the weighing system has three weighing sensors for weighing feed received in the container, the frame has three weighing sensor jacking points and three or more jacks are provided. This makes it possible for all of the weighing sensors to be protected against overloading by means of the jacks during transport in the lorry.

In an embodiment according to the invention, the container is lifted up by means of the at least one jack to a distance above the weighing sensor in order to release this weighing sensor when this jack is fitted at the weighing sensor jacking point and is in the raising position. In particular, when a plurality of weighing sensors, jacks and weighing sensor jacking points are used, the container can be lifted up by means of the jacks to a distance above each weighing sensor in order to release the weighing sensors when the jacks are fitted at the weighing sensor jacking points and are in the raising position. When the at least one weighing sensor is released, the container rests on the one or more jacks without making contact with the weighing sensor or weighing sensors. The weighing sensor or weighing sensors are completely relieved of load. The container is located at a distance above the weighing sensor or weighing sensors. This allows a fitter to easily remove and replace the weighing sensor or weighing sensors during maintenance work.

In an embodiment according to the invention, the feed carriage comprises at least three wheels and the system comprises at least three jacks, wherein the frame of the feed carriage comprises at least three wheel jacking points for fitting a respective one of the jacks below the frame in such a way that (i) the wheels are supported on the underlying surface when the jacks are fitted in the lowering position at the wheel jacking points, and (ii) the jacks fitted at the wheel jacking points lift up the frame in order to release the wheels from the underlying surface when these jacks are actuated and/or adjusted from the lowering position to the raising position. A respective corresponding wheel jacking point is added to each wheel. Preferably, the number of jacks is at least equal to the number of wheels and the number of wheel jacking points. In other words, if the feed carriage has three wheels, the frame is designed with three wheel jacking points and three or more jacks are provided. This makes it possible for all of the wheels to be simultaneously lifted up from the underlying surface by means of the jacks, such that all of the wheels can be replaced at once. When the feed carriage rests on the jacks with all the wheels free above the underlying surface, the feed carriage also stands particularly stably and the risk of tipping over is minimal.

In a particular preferred embodiment, the frame of the feed carriage has one front wheel and two rear wheels, wherein the front wheel extends substantially in a longitudinal central plane of the feed carriage, and the rear wheels are fitted alongside each other at a distance from the longitudinal central plane and are rotatable about a common axis of rotation, and wherein the frame of the feed carriage is provided with two rear wheel jacking points for fitting a respective jack below the frame in order to, in the raising position thereof, release the respective rear wheels from the underlying surface, and with a front wheel jacking point for fitting a further jack below the frame in order to, in the raising position thereof, release the front wheel from the underlying surface, and wherein, as seen in a direction from the rear wheels towards the front wheel, one of the rear wheel jacking points extends behind the axis of rotation of the rear wheels and the other rear wheel jacking point extends in front of the axis of rotation of the rear wheels. If both rear wheel jacking points were to be located behind the axis of rotation of the wheels and the frame of the feed carriage were to be lifted up at one of the rear wheel jacking points, the jack of the other rear wheel jacking point could form a tilting axis together with the jack of the front wheel jacking point. There would then be the risk of the feed carriage tilting about this tilting axis when being jacked up, and potentially even tipping over. When the first and second rear wheel jacking point are fitted behind and, respectively, in front of the axis of rotation of the rear wheels, the mutual distances between the jacking points can be substantially identical. This reduces the risk of the feed carriage tipping over when being jacked up.

In an embodiment according to the invention, the at least one jack is detachably fitted at the wheel jacking point or at the weighing sensor jacking point. The term “detachably” should be understood to mean that the jack can be removed from a jacking point, either a wheel jacking point or a weighing sensor jacking point, without causing damage, and this jack can subsequently be fitted at the same or a different jacking point, either a wheel jacking point or a weighing sensor jacking point. It is possible to detach the jack and subsequently use it at a different jacking point. Preferably, the jack, after the detachment thereof, is moveable from the wheel jacking point to the weighing sensor jacking point and the detached jack can subsequently be detachably fitted at this weighing sensor jacking point. Conversely, it is also possible for the jack, after the detachment thereof, to be moveable from the weighing sensor jacking point to the wheel jacking point, after which the detached jack is detachably connected to this wheel jacking point.

For example, the feed carriage comprises three or more wheels and corresponding wheel jacking points, and three or more weighing sensors and corresponding weighing sensor jacking points. The number of jacks is preferably equal to the number of weighing sensors and/or the number of wheels. Let us suppose that, during transport with the lorry from the factory to a farm, the jacks were fitted in the raising position at the weighing sensor jacking points. After arrival at the farm, the jacks are lowered, such that the container of the feed carriage is supported on the weighing sensors and the weighing sensors can measure feed received in the container. The jacks can remain fitted in the lowering position at the weighing sensor jacking points, for example so as not to lose the jacks. However, the jacks are detachable from the weighing sensor jacking points in the lowering position. The jacks can be used to change one or more of the wheels. The jacks are then detached and moved to the wheel jacking points, and are subsequently detachably connected thereto. The actuation of the jacks to the raising position lifts up the frame and releases the wheels from the underlying surface. It is also possible for the jacks to be detached from the wheel jacking points in the lowering position. The jacks can then be moved (back) to the weighing sensor jacking points in order to relieve the load on the weighing sensors, for example in order to transport the feed carriage again or to replace one or more of the weighing sensors.

In an embodiment according to the invention, the at least one jack, the at least one wheel jacking point and the at least one weighing sensor jacking point are designed in such a way that,
when the jack is fitted at the wheel jacking point and is in the raising position, this jack is supported on the underlying surface and lifts up the frame in order to release this wheel from the underlying surface, in particular by engaging with a bottom side of the wheel jacking point, and,
when this same jack is fitted at the weighing sensor jacking point and is in the raising position, this jack is supported on the frame, in particular by engaging with a top side of the weighing sensor jacking point, and lifts up the container in order to relieve the load on this weighing sensor.

The design and the embodiment of the one or more jacks, wheel jacking points and weighing sensor jacking points are adapted to each other in such a way that the jacks can perform the above-described dual function. When the jacks are fitted at the wheel jacking points, the jacks are located between the underlying surface and the frame. In the raising position, the jacks are supported on the underlying surface and preferably engage with a bottom side of the wheel jacking points. The frame can be lifted up in order to release the wheels from the underlying surface (first function). When the jacks are detached from the wheel jacking points and fitted at the weighing sensor jacking points, the jacks are located between the frame and the container. In the raising position, the jacks are supported on the frame by engaging with a top side of the weighing sensor jacking points. The container can be lifted up in order to relieve the load on the weighing sensors (second function).

In an embodiment according to the invention, the system comprises a plurality of jacks, wherein all the jacks are of identical design. In order to perform the above-described dual function, the jacks are substantially the same or identical. In this way, the jacks are exchangeable with each other and the jacks can be detachably fitted at each wheel jacking point and at each weighing sensor jacking point. This is favourable for the ease of use.

In an embodiment according to the invention, the feed carriage is autonomous and/or unmanned. For example, the feed carriage comprises a drive and steering system for driving and steering the feed carriage, wherein the drive and steering system is provided with at least one electric drive motor, and an electronic control system which is connected to the drive and steering system for the control thereof. Preferably, the feed carriage comprises a battery system for storing electrical energy, wherein the battery system is connected to the drive and steering system and the control system. Controlling the drive and steering system makes it possible to define the speed and the direction of the movement of the feed carriage. By means of the control system, the feed carriage can autonomously move along a route. It is also possible for the autonomous feed carriage to be guided along a route by means of a guide device. The guide device comprises, for example, a guide track fitted to or in the floor. However, the feed carriage may for example also be suspended from a guide rail which extends through an animal shed.

The invention also relates to a feed carriage for feeding animals, such as cows, in particular dairy cows or beef cows, wherein the feed carriage comprises:
a frame with wheels, by means of which the feed carriage is moveable over an underlying surface, such as a floor,
a container for receiving a batch of feed, wherein the container is fitted to the frame,
a weighing system for weighing feed received in the container, wherein the weighing system comprises at least one weighing sensor, and
   wherein the frame of the feed carriage comprises:
at least one wheel jacking point for fitting a jack below the frame in such a way that (i) the wheel closest to the wheel jacking point is supported on the underlying surface when this jack is fitted in a lowering position at the wheel jacking point, and (ii) the jack fitted at the wheel jacking point lifts up the frame in order to release this wheel from the underlying surface when the jack is actuated and/or adjusted from the lowering position to a raising position, and
at least one weighing sensor jacking point for fitting this same jack in such a way that (i) the container is supported on the frame by means of the weighing sensor when the jack is fitted in the lowering position at the weighing sensor jacking point, and (ii) the jack fitted at the weighing sensor jacking point lifts up the container in order to relieve the load on the weighing sensor when the jack is actuated and/or adjusted from the lowering position to the raising position.

The frame of the feed carriage according to the invention comprises one or more wheel jacking points, which are known per se from the prior art, and also one or more weighing sensor jacking points which are designed and adapted in such a way that the jack which is usable at the wheel jacking points is also suitable for use at the weighing sensor jacking points. The advantages and technical effects are the same as described above for the system for feeding animals according to the invention.

The feed carriage may be designed as described above in relation to the system for feeding animals. In particular, the feed carriage may be designed according to the feature of one or more of claims 2-13.

In a preferred embodiment according to the invention, the feed carriage comprises at least three wheels, wherein the weighing system comprises at least three weighing sensors, and wherein the frame of the feed carriage comprises at least three wheel jacking points and at least three weighing sensor jacking points for the fitting of a respective jack, and wherein the wheel jacking points and the weighing sensor jacking points of the frame are designed in such a way that (i) the wheels are supported on the underlying surface when three jacks, which are preferably identical, are fitted in the lowering position at the wheel jacking points, and (ii) these jacks fitted at the wheel jacking points lift up the frame in order to release the wheels from the underlying surface when these jacks are actuated and/or adjusted from the lowering position to the raising position, and (iii) the container is supported on the frame by means of the weighing sensors when these same jacks are fitted in the lowering position at the weighing sensor jacking points, and (iv) these jacks fitted at the weighing sensor jacking points lift up the container in order to relieve the load on the weighing sensors when the jacks are actuated and/or adjusted from the lowering position to the raising position.

The invention also relates to the use of a system as described above, i.e. to a method for using such a system, wherein the use or this method comprises:
fitting, at a first location, the at least one jack in the lowering position at the at least one weighing sensor jacking point,
actuating and/or adjusting this jack from the lowering position to the raising position in order to lift up the container so as to relieve the load on the at least one weighing sensor,
securing the feed carriage to a loading floor of a transport device, such as a lorry, for example by means of lashing straps which are tensioned over the container in order to brace the feed carriage on the loading floor,
transporting the feed carriage by means of the transport device from the first location to a second location,
actuating and/or adjusting, at the second location, this jack from the raising position to the lowering position in order for the container to be supported on the frame by means of this weighing sensor,
detaching this jack in the lowering position, moving this jack from this weighing sensor jacking point to the at least one wheel jacking point, and fitting the jack at this wheel jacking point,
actuating and/or adjusting this jack from the lowering position to the raising position in order to lift up the frame in order to release the wheel closest to this wheel jacking point from the underlying surface.

This use or this method according to the invention has the same technical effects and advantages as described above in relation to the system for feeding animals according to the invention.

It is preferable in this use or this method for the feed carriage to comprise at least three wheels, for the weighing system to comprise at least three weighing sensors, and for the system to comprise at least three jacks which are preferably identical, wherein the frame of the feed carriage comprises at least three wheel jacking points and at least three weighing sensor jacking points for the fitting of a respective one of the jacks. In this case, the use or this method comprises:
fitting, at the first location, the jacks in the lowering position at a respective one of the weighing sensor jacking points,
actuating and/or adjusting the jacks from the lowering position to the raising position in order to lift up the container so as to relieve the load on the weighing sensors,
securing the feed carriage to a loading floor of a transport device, such as a lorry, for example by means of lashing straps which are tensioned over the container in order to brace the feed carriage on the loading floor,
transporting the feed carriage by means of the transport device from the first location to a second location,
actuating and/or adjusting, at the second location, the jacks from the raising position to the lowering position in order for the container to be supported on the frame by means of the weighing sensors,
detaching the jacks in the lowering position, moving these jacks from the weighing sensor jacking points to the wheel jacking points, and fitting the jacks at a respective one of the wheel jacking points,
actuating and/or adjusting the jacks from the lowering position to the raising position in order to lift up the frame in order to release the wheels from the underlying surface.

The invention will now be explained in more detail by means of an exemplary embodiment illustrated in the figures.

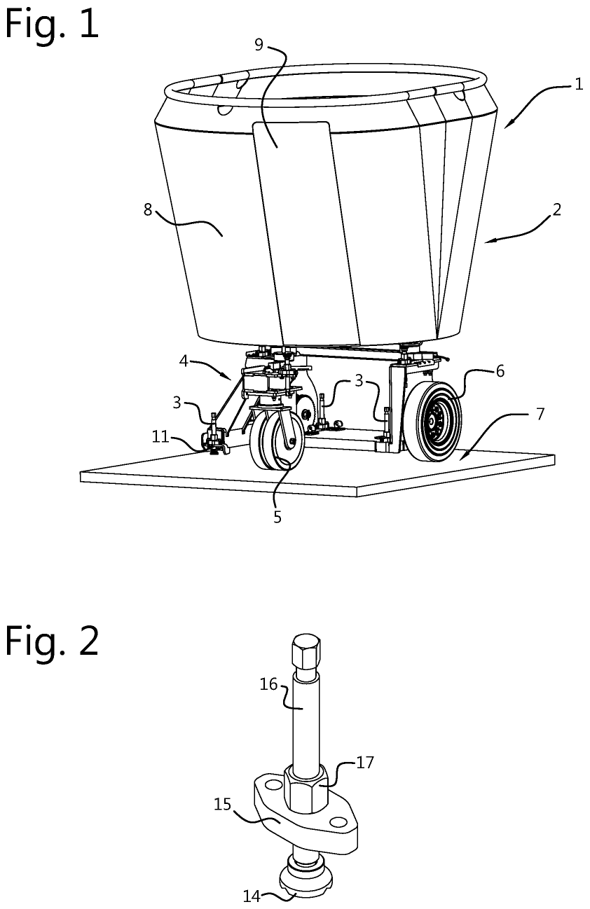

FIG. 1 shows a partially cut-away perspective view of a system for feeding animals according to the invention, comprising a feed carriage and three jacks.

FIG. 2 shows a perspective view of a jack of the system illustrated in FIG. 1.

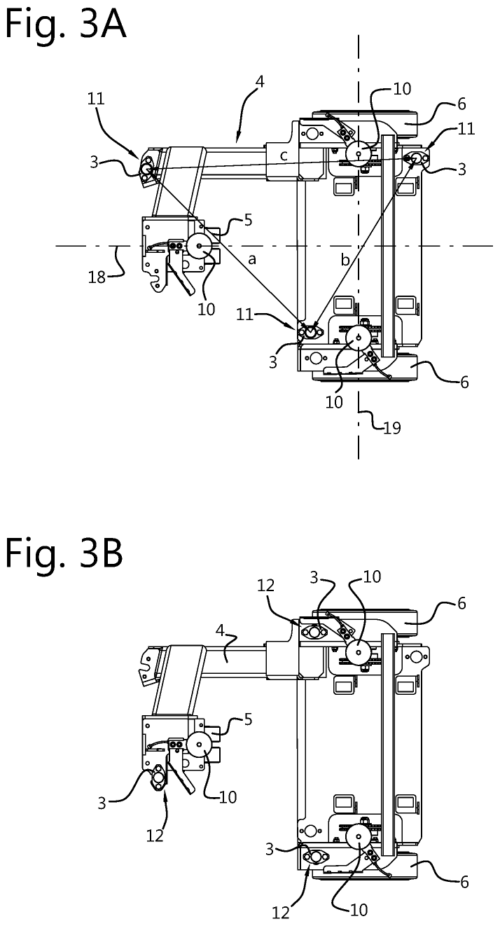

FIGS. 3A and 3B show top views of a frame of the feed carriage of the system illustrated in FIG. 1, the jacks being fitted at wheel jacking points and, respectively, weighing sensor jacking points.

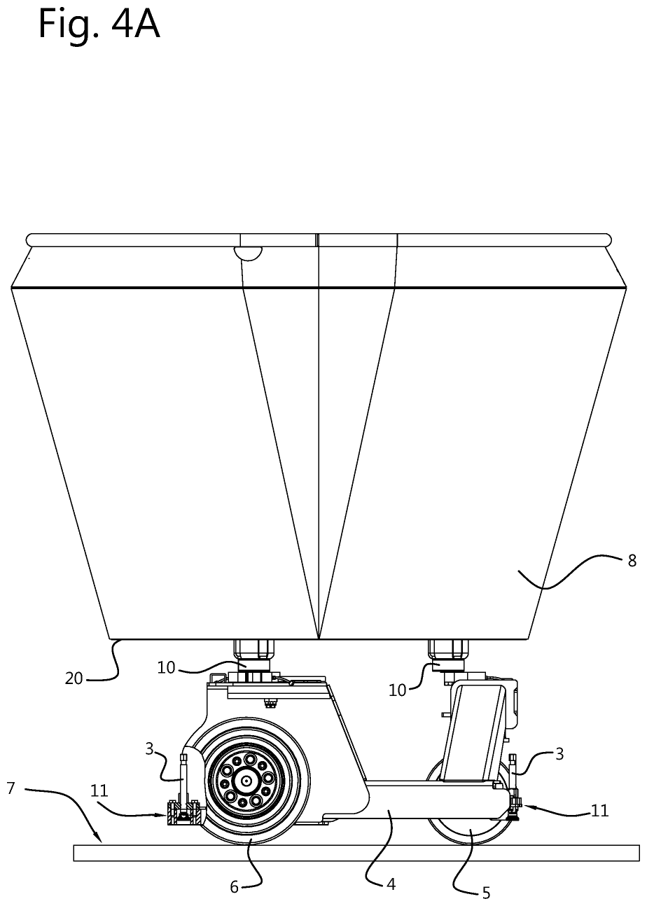

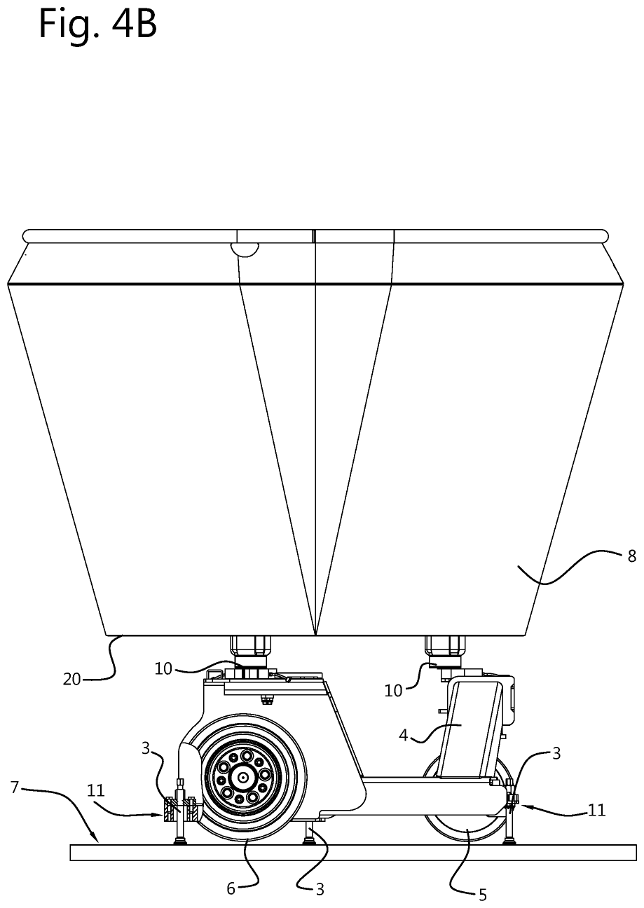

FIGS. 4A and 4B show side views of the feed carriage of the system illustrated in FIG. 1, the wheels of the feed carriage being supported on the underlying surface and, respectively, being lifted up from the underlying surface by means of the jacks.

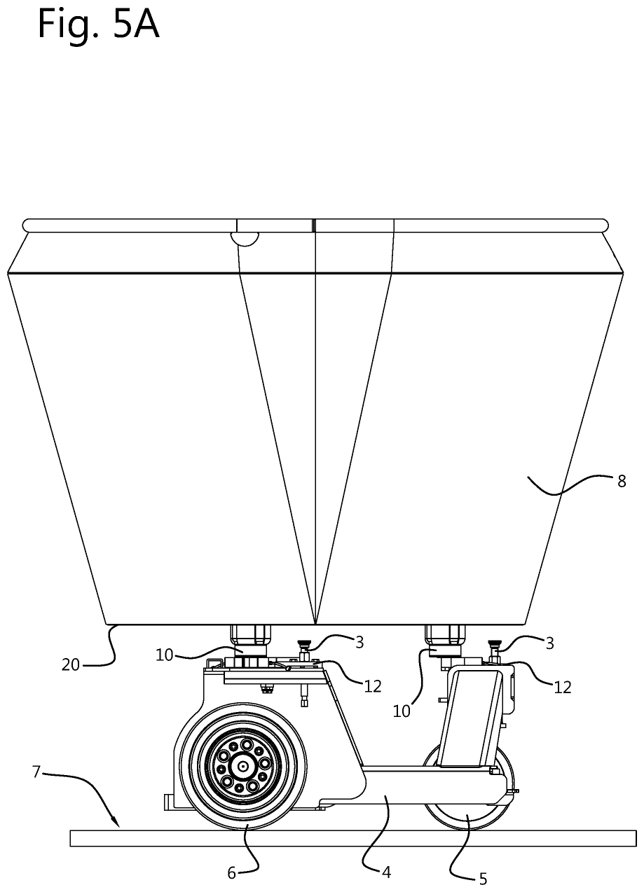

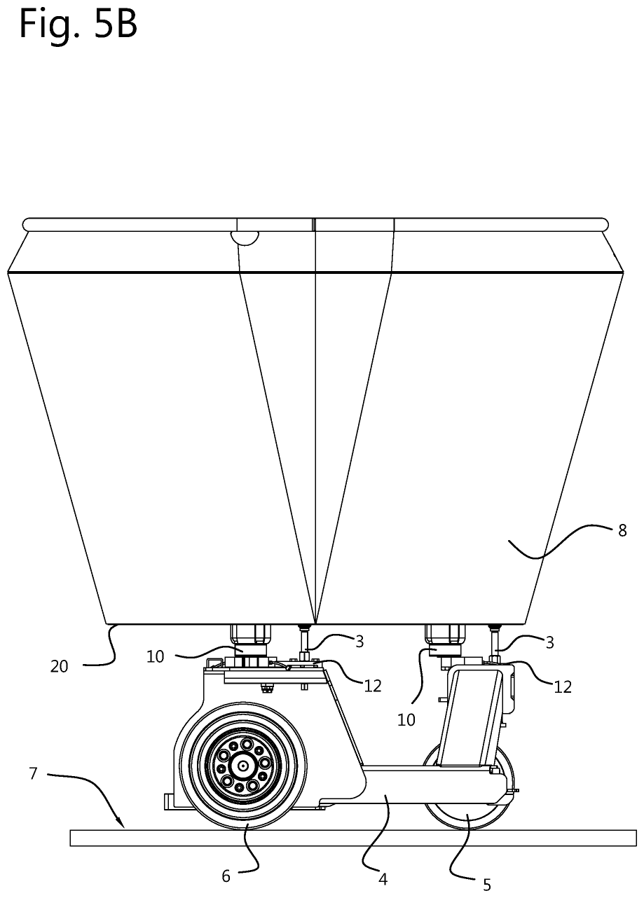

FIGS. 5A and 5B show side views of the feed carriage of the system illustrated in FIG. 1, the container of the feed carriage being supported on the frame by means of weighing sensors and, respectively, being lifted up by means of the jacks in order to relieve the load on the weighing sensors.

The system 1 shown in FIG. 1 for feeding animals, in particular cows, such as dairy cows or beef cows, comprises a feed carriage 2 and three jacks 3 (see also FIGS. 3A and 3B).

The feed carriage 2 comprises a frame 4 with wheels 5, 6, by means of which the feed carriage 2 is moveable over an underlying surface 7, such as a floor. In this exemplary embodiment, the feed carriage 2 comprises one front wheel 5 and two rear wheels 6. The front wheel 5 is positioned substantially in a longitudinal central plane 18 of the feed carriage 2 (see FIG. 3A). The rear wheels 6 lie alongside each other at a distance from the longitudinal central plane and are rotatable about a common axis of rotation 19.

The feed carriage 2 comprises a container 8 for receiving a batch of feed. The container 8 is fitted to the frame 4. The container 8 comprises a base 20 and a peripheral wall which extends upwards from the base 20 (see FIG. 4A). The feed carriage 2 comprises a feed dispensing device for laterally dispensing feed from the container 8, in particular to the left and/or to the right of the feed carriage 2. In this exemplary embodiment, the feed dispensing device comprises a dispensing opening provided in the peripheral wall of the container 8. A door 9 is slidably moveable upwards from a closed position to an open position. When the door 9 is opened, feed received in the container 8 can be metered out. The feed carriage 2 is for example used to distribute feed along one or more feed fences, such as in an animal shed (not shown).

In this exemplary embodiment, the feed carriage 2 is self-propelled and autonomous. The feed carriage 2 comprises a drive and steering system for driving and steering the feed carriage. The drive and steering system is not illustrated in the figures, but comprises at least one electric drive motor, and an electronic control system which is connected to the drive and steering system for the control thereof. The feed carriage 2 comprises a battery system for storing electrical energy (not shown in the figures). The battery system is connected to the drive and steering system and the control system. Controlling the drive and steering system makes it possible to define the speed and the direction of the movement of the feed carriage 2. By means of the control system, the feed carriage 2 can autonomously move along a route in order to deliver feed to the animals. It is possible for the autonomous feed carriage 2 to be guided along a route by means of a guide device. The guide device comprises, for example, a guide track fitted to or in the floor. The feed carriage 2 may for example also be suspended from a guide rail which is fastened to the animal shed (not shown).

In order to weigh the feed received in the container 8, the feed carriage 2 comprises a weighing system which, in this exemplary embodiment, comprises three weighing sensors 10 (see FIG. 3A). The weighing sensors 10 are designed as “load cells”. When the container 8 with received feed rests on the weighing sensors 10, the force exerted on each weighing sensor 10 is converted into an electrical signal. On the basis of the electrical signals from the weighing sensors 10, it is possible to accurately determine the weight of the feed received in the container 8.

As mentioned above, the system 1 comprises three jacks 3 in this exemplary embodiment. The three jacks 3 are identical to each other. As shown in FIG. 2, each jack 3 comprises a first engaging part 14, a second engaging part 15, a threaded spindle 16 and a lock nut 17. The engaging parts 14, 15 can be moved away from or towards each other in the longitudinal direction of the threaded spindle 16 by rotating the threaded spindle 16 by means of a drive (not shown). When the engaging parts 14, 15 are adjusted to a desired distance from each other, this distance can be secured with the lock nut 17. It goes without saying that the jacks 3 may also be of different design, for example hydraulic or pneumatic.

The jacks 3 are therefore each actuatable and/or adjustable between a lowering position and a raising position. In addition, the jacks 3 are each securable in both the lowering position and the raising position. In the lowering position, the engaging parts 14, 15 are located at a first distance from each other. In the raising position, the engaging parts 14, 15 are at a second distance from each other, which is greater than the first distance. The engaging parts 14, 15 are moved apart from each other from the lowering position to the raising position. In order to reach the lowering position from the raising position, the engaging parts 14, 15 move towards each other.

As is known per se, the jacks 3 can be used to replace one or more wheels 5, 6 of the feed carriage 2. The frame 4 of the feed carriage 2 is provided with three wheel jacking points 11 for fitting a respective one of the jacks 3 below the frame 4, namely a first and second rear wheel jacking point for the fitting of a first and, respectively, second jack and a front wheel jacking point for the fitting of a third jack. The jacks 3 can be detachably connected to the wheel jacking points 11.

When the three jacks 3 are fitted in the lowering position at the wheel jacking points 11 and are located above the underlying surface 7, the wheels 5, 6 are supported on the underlying surface 7 (see FIGS. 3A and 4A). Subsequent actuation of the jacks 3 fitted at the wheel jacking points 11 from the lowering position to the raising position causes the first engaging parts 14 of the jacks 3 to engage with the underlying surface 7. At the same time, the second engaging parts 15 of the jacks 3 engage with a bottom side of the wheel jacking points 11 in order to lift up the frame 4 as a whole in such a way that the wheels 5, 6 come free from the underlying surface 7 (see FIG. 4B). In the raising position, the jacks 3 can be secured by means of the lock nut 17. A fitter can then change the released wheels 5, 6.

In this exemplary embodiment, one of the rear wheel jacking points 11 lies, as seen in a direction from the rear wheels 6 towards the front wheel 5, that is to say in a direction of forward travel, behind the axis of rotation 19 of the rear wheels 6, whereas the other rear wheel jacking point 11 extends in front of this axis of rotation 19 of the rear wheels 6. In this way, the differences between the mutual distances a, b, c between the wheel jacking points 11 (see FIG. 3A) are so small that the feed carriage 2 remains stable when being jacked up and the risk of tipping over is minimal. If, for example, the rear wheel jacking point 11 that is located in front of the axis of rotation 19 of the rear wheels 6 were to lie behind this axis of rotation 19 instead, then this rear wheel jacking point 11 can form a tilting axis together with the front wheel jacking point 11 if the other rear wheel jacking point 11 is moved upwards first or more quickly during the jacking up.

According to the invention, the jacks 3 have a dual function. When transporting the feed carriage 2 for example with a lorry from a first location to a second location, such as from the factory where the feed carriage 2 is manufactured to a farm or from a first farm to a second farm, lashing straps are often tensioned over the container 8 of the feed carriage 2 in order to firmly secure the feed carriage 2 to the loading floor of the lorry. As a result, the maximum load of the weighing sensors 10 may be exceeded, with the result that the weighing sensors 10 are damaged. In order to protect the weighing sensors 10 against overloading, the jacks 3 according to the invention have a second function. In order to make the second function of the jacks 3 possible, the frame 4 of the feed carriage 2 is also provided, in addition to the wheel jacking points 11, with three weighing sensor jacking points 12 for the fitting of a respective one of the jacks 3 (see FIG. 3B).

The number of jacks 3 is equal to or greater than the number of weighing sensors 10 and/or the number of weighing sensor jacking points 12 and/or the number of wheels 5, 6 and/or the number of wheel jacking points 11. As already mentioned above, the jacks 3 are detachably fastenable to the wheel jacking points 11. The jacks 3 can also be detachably connected to the weighing sensor jacking points 12. In this exemplary embodiment, the jacks 3 are inverted when the jacks 3 are moved from the wheel jacking points 11 to the weighing sensor jacking points 12.

When the jacks 3 are not fitted at the weighing sensor jacking points 12, the container 8 rests on the frame 4 via the weighing sensors 10. When the jacks 3 are fitted in the lowering position at the weighing sensor jacking points 12, the container 8 is still supported on the frame 4 by means of the weighing sensors 10 (see FIG. 5A). The weighing sensors 10 are then active, that is to say that the weighing sensors 10 weigh the feed received in the container 8. Subsequent actuation of the jacks 3 fitted at the weighing sensor jacking points 12 from the lowering position to the raising position causes the second engaging parts 15 of the jacks 3 to engage with the top side of the weighing sensor jacking points 12 of the frame 4. At the same time, the first engaging parts 14 of the jacks 3 engage with a bottom side of the base 20 of the container 8 in order to lift up the container 8 in such a way that the weighing sensors 10 are relieved of load (see FIG. 5B). The jacks 3 can again be secured in the raising position by means of the lock nut 17.

The feed carriage 2 can then be transported with a lorry without the risk of the weighing sensors 10 being overloaded. If the container 8 is for example firmly braced on the frame 4 by means of lashing straps, the jacks 3 form a stop which protects the weighing sensors 10. After transport, the jacks 3 can be lowered again, such that the weighing sensors 10 can determine the weight of feed received in the container 8. Since the jacks 3 are detachably connected to the weighing sensor jacking points 12, the jacks 3 can subsequently be detached and moved to for example the wheel jacking points 11 in order to change one or more wheels 5, 6 as described above.

In this exemplary embodiment, the jacks 3 can also be used during maintenance on the weighing sensors 10. When the jacks 3 fitted at the weighing sensor jacking points 12 have reached the raising position, the container 8 is lifted upwards in such a way that the base 20 of the container 8 is at a distance above the weighing sensors 10. A fitter can then easily replace the weighing sensors 10.

The invention is not restricted to the exemplary embodiment illustrated in the figures. For example, the feed carriage does not have to be autonomous, but may also be configured to be towed by a tractor.

1. A system for feeding animals including cows, wherein the system comprises:
with a feed carriage including:
a frame with wheels by which the feed carriage is moveable over an underlying surface including a floor,
a container for receiving a batch of feed, wherein the container is fitted to the frame,
a weighing system for weighing feed received in the container, wherein the weighing system comprises at least one weighing, and
at least one jack, which is actuatable between a lowering position and a raising position,
wherein the frame of the feed carriage comprises:
at least one wheel jacking point for fitting the jack below the frame so (i) the wheel closest to the wheel jacking point is supported on the underlying surface when the jack is fitted in the lowering position at the wheel jacking point, and (ii) the jack fitted at the wheel jacking point lifts up the frame in order to release said wheel from the underlying surface when the jack is actuated from the lowering position to the raising position, wherein the frame of the feed carriage further comprises:
at least one weighing sensor jacking point for fitting said jack so that (i) the container is supported on the frame by the weighing sensor when the jack is fitted in the lowering position at the weighing sensor jacking point, and (ii) the jack fitted at the weighing sensor jacking point lifts up the container in order to relieve the load on the weighing sensor when the jack is actuated from the lowering position to the raising position.

2. The system according to claim 1, wherein the feed carriage includes a feed dispensing device for laterally dispensing feed from the container, to distribute feed along one or more feed fences, including in an animal shed.

3. The system according to claim 1, wherein the weighing sensor jacking point for the fitting of said jack is configured and/or adapted so the jack which is configured to be fitted at the wheel jacking point and/or is usable at the wheel jacking point can also be fitted at the weighing sensor jacking point and/or is suitable for use at the weighing sensor jacking point.

4. The system according to claim 1, wherein the at least one jack, the at least one wheel jacking point and the at least one weighing sensor jacking point are configured to,
when the jack is fitted at the wheel jacking point and is in the raising position, said jack is supported on the underlying surface and lifts the frame in order to release said wheel from the underlying surface, and
when the jack is fitted at the weighing sensor jacking point and is in the raising position, said jack is supported on the frame and lifts the container in order to relieve the load on said weighing sensor.

5. The system according to claim 1, wherein the weighing system comprises at least three weighing sensors and the system comprises at least three jacks, and
wherein the frame of the feed carriage comprises at least three weighing sensor jacking points for fitting a respective one of the jacks so that (i) the container is supported on the frame by the weighing sensors when the jacks are fitted in the lowering position at the weighing sensor jacking points, and (ii) the jacks fitted at the weighing sensor jacking points lift the container in order to relieve the load on the weighing sensors when the jacks are actuated from the lowering position to the raising position.

6. The system according to claim 1, wherein the container is lifted by the at least one jack to a distance above the weighing sensor in order to release said weighing sensor when said jack is fitted at the weighing sensor jacking point and is in the raising position.

7. The system according to claim 1, wherein the feed carriage comprises at least three wheels and the system comprises at least three jacks, and
wherein the frame of the feed carriage comprises at least three wheel jacking points for fitting a respective one of the jacks below the frame so that (i) the wheels are supported on the underlying surface when the jacks are fitted in the lowering position at the wheel jacking points, and (ii) the jacks fitted at the wheel jacking points lift up the frame in order to release the wheels from the underlying surface when said jacks are actuated from the lowering position to the raising position.

8. The system according to claim 1, wherein the frame of the feed carriage has one front wheel and two rear wheels,
wherein the front wheel extends substantially in a longitudinal central plane of the feed carriage, and the rear wheels are fitted next to each other at a distance from the longitudinal central plane and are rotatable about a common axis of rotation,
wherein the frame of the feed carriage includes a first and second rear wheel jacking point for fitting a first and second jack below the frame in order to, in the raising position thereof, release the respective rear wheels from the underlying surface, and with a front wheel jacking point for fitting a third jack below the frame in order to, in the raising position thereof, release the front wheel from the underlying surface, and
wherein, as seen in a direction from the rear wheels towards the front-wheel wheel, the first rear wheel jacking point extends behind the axis of rotation of the rear wheels and the second rear wheel jacking point extends in front of the axis of rotation of the rear wheels.

9. The system according to claim 1, wherein the at least one jack is detachably fitted at the wheel jacking point or at the weighing sensor jacking point.

10. The system according to claim 9, wherein said jack, after the detachment thereof, is moveable from said wheel jacking point or weighing sensor jacking point to the other jacking point and is detachably fittable at said other jacking point.

11. The system according claim 1, wherein the system comprises a plurality of jacks, and
wherein all the jacks are of identical design.

12. The system according to claim 11, wherein a number of jacks is equal to or greater than the number of weighing sensors and/or the number of weighing sensor jacking points and/or the number of wheels and/or the number of wheel jacking points.

13. The system according to claim 1, wherein the feed carriage is autonomous.

14. A feed carriage for feeding animals including cows, wherein the feed carriage comprises:
a frame with wheels, by which the feed carriage is moveable over an underlying surface including a floor,
a container for receiving a batch of feed, wherein the container is fitted to the frame,
a weighing system for weighing feed received in the container, wherein the weighing system comprises at least one weighing sensor, and
wherein the frame of the feed carriage comprises:
at least one wheel jacking point for fitting a jack below the frame so that (i) the wheel closest to the wheel jacking point is supported on the underlying surface when said jack is fitted in the lowering position at the wheel jacking point, and (ii) the jack fitted at the wheel jacking point lifts up the frame in order to release said wheel from the underlying surface when the jack is actuated from the lowering position to the raising position,
wherein the frame of the feed carriage further comprises:
at least one weighing sensor jacking point for fitting said jack so that (i) the container is supported on the frame by the weighing sensor when the jack is fitted in the lowering position at the weighing sensor jacking point, and (ii) the jack fitted at the weighing sensor jacking point lifts up the container in order to relieve the load on the weighing sensor when the jack is actuated from the lowering position to the raising position.

15. The feed carriage according to claim 14, wherein the feed carriage comprises at least three wheels,
wherein the weighing system comprises at least three weighing sensors,
wherein the frame of the feed carriage comprises at least three wheel jacking points and at least three weighing sensor jacking points for the fitting of a respective jack, and
wherein the wheel jacking points and the weighing sensor jacking points of the frame are configured in such a way that (i) the wheels are supported on the underlying surface when three jacks are fitted in the lowering position at the wheel jacking points, and (ii) said jacks fitted at the wheel jacking points lift up the frame in order to release the wheels from the underlying surface when said jacks are actuated from the lowering position to the raising position, and (iii) the container is supported on the frame by the weighing sensors when these same are fitted in the lowering position at the weighing sensor jacking points, and (iv) said jacks fitted at the weighing sensor jacking points lift up the container in order to relieve the load on the weighing sensors when the jacks are actuated from the lowering position to the raising position.

16. A method of using the system according to claim 1, wherein the method comprises:
fitting, at a first location, the at least one jack in the lowering position at the at least one weighing sensor jacking point,
actuating said jack from the lowering position to the raising position in order to lift up the container so as to relieve the load on the at least one weighing sensor,
securing the feed carriage to a loading floor of a transport device including a lorry,
transporting the feed carriage by the transport device from the first location to a second location,
actuating, at the second location, said jack from the raising position to the lowering position in order for the container to be supported on the frame by said weighing sensor,
detaching said jack in the lowering position, moving said jack from said weighing sensor jacking point to the at least one wheel jacking point, and fitting the jack at said wheel jacking point, and
actuating said jack from the lowering position to the raising position in order to lift up the frame in order to release the wheel closest to said wheel jacking point from the underlying surface.
